(19) United States
(12) Patent Application Publication
(10) Pub. No.: US 2004/0225580 A1
(43) Pub. Date: Nov. 11, 2004

(54) Lease termination method

(76) Inventors: Bernard Gelman, Philadelphia, PA (US); James Joseph Broussard, Drexel Hill, PA (US)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(21) Appl. No.: 10/867,241

(22) Filed: Jun. 14, 2004

Related U.S. Application Data
(63) Continuation-in-part of application No. 10/827,728, filed on Apr. 20, 2004.
Application No. 10/827,728 is a continuation-in-part of application No. 09/589,701, filed on Jun. 8, 2000, now Pat. No. 6,735,573.

(51) Int. Cl. G06F 17/60

(52) U.S. Cl. 705/30; 705/40

(57) ABSTRACT

A method for derecognizing the commitment of a lessee in an operating lease includes holding by a lessee a recognized operating lease wherein the recognized operating lease has an obligation to a lessor, including an obligation to make a rental payment and a fixed future value S₁ and determining the present value P₁ of the recognized operating lease in accordance with the fixed future value S₁. The recognized operating lease is bought from the lessee by a buyer entity for a present value P₂ greater than the present value P₁ wherein the lessee releases the obligation to make the rental payment thereby providing a first net gain to the lessee whereby the recognized operating lease is derecognized to provide a derecognized operating lease. Holding the derecognized operating lease and storing information regarding the derecognized operating lease in a computer by the buyer entity for a period of time are also required.

### RELATED APPLICATION

This application is a continuation-in-part of U.S. patent application Ser. No. 10/827,728 filed Apr. 20, 2004 entitled “Risk Reduction System”, which is a continuation-in-part of U.S. patent application Ser. No. 09/589,701 filed Jun. 8, 2000 entitled “Lease Termination Method,” both of which are assigned to the same assignee as this invention and whose disclosure is incorporated by reference herein.

### FIELD OF THE INVENTION

This invention relates to the fields of lease termination and risk analysis.

### BACKGROUND OF THE INVENTION

In order to establish uniformity in financial statement presentation the American Institute of Certified Public Accountants (AICPA) has published many writings. These writings are collectively referred to as Generally Accepted Accounting Principals (GAAP). GAAP establishes how, where, when and how much is reported on a financial statement. GAAP is required to be used by most businesses but not all. There are some exceptions.

According to GAAP, liabilities must be recorded at their face value. Current liabilities are defined as those that should be paid in one year's time or less from the Balance Sheet date. Long-term obligations are defined as those that are due to be paid after one year from the balance sheet date. For example, an account payable due in thirty (30) days for $100 would be recorded as a current liability of $100. In the case of a note payable due in ten (10) years the debt would be recorded as a long-term debt.

Whether a debt is an account payable or a note, it is thus recorded at its face value. No consideration is made of the present value of a future obligation when recording the debt. In fact GAAP forbids the recordation of a liability for any amount other than its face amount. However it is well known that long-term liabilities have a present value less than the face value at which they are recorded. Thus, the recorded value is greater than the actual present value but most companies must carry the greater value on their books in order to comply with GAAP.

Therefore, in order to avoid this inequity in GAAP some companies might find it desirable to sell one or more of its long-term obligations for a sum that approximates the present value of this debt. In order to accomplish this objective the debtor must derecognize this liability. According to GAAP in order for a liability to be extinguished one of the following conditions must be met:

The debtor pays the creditor and is relieved of its obligation for the liability. Or, the debtor is legally released from being the primary obliger under the liability, either judicially or by the creditor.

Liabilities are defined by GAAP as “probable future sacrifices of economic benefits arising from present obligations of a particular entity to transfer assets or provide services to other entities in the future as a result of past transactions or events.” Items that would otherwise be classified as a liability would not be recognized as a liability if insured under a contract of insurance with a recognized insurance carrier. An example would be a company that is self insured for worker's compensation. The company's future loss obligations would be reflected as a liability on its financial statement according to GAAP. If the company were to then purchase a workers' compensation insurance contract, the liability would be derecognized in exchange for the premium paid to the insurance carrier.

The purchaser of the debt would therefore have to be an insurance carrier unless there are changes in the relevant rules or laws, or changes in the interpretation of the relevant rules of laws. The purchaser of the debt must be able to make a profit otherwise there is no business purpose for them to enter into the transaction. The insurance company would therefore charge a premium in excess of the present value of the obligation. The total sum paid by the seller would still be less than the face amount. Both buyer and seller profit.

### SUMMARY OF THE INVENTION

A method for derecognizing the commitment of a lessee in an operating lease includes holding by a lessee a recognized operating lease wherein the recognized operating lease has an obligation to a lessor, including an obligation to make a rental payment, and a fixed future value S₁ and determining the present value P₁ of the recognized operating lease in accordance with the fixed future value S₁. The recognized operating lease is bought from the lessee by a buyer entity for a present value P₂ greater than the present value P₁ wherein the lessee releases the obligation to make the rental payment thereby providing a first net gain to the lessee whereby the recognized operating lease is derecognized to provide a derecognized operating lease. Holding the derecognized operating lease and storing information regarding the derecognized operating lease in a computer by the buyer entity for a period of time are also required. The liability of the derecognized operating lease is discharged at the end of the period of time by the buyer entity for the future value S₁ that is less than a future value S₂ determined in accordance with the present value P₂ thereby providing a second net gain to the buyer entity. The present value P₂ is determined according to the present value P₁. The present value P₁ is determined according to a time t years prior to the time at which the value of the lessee retained obligation reaches S₁. The buyer entity holds the lessee retained obligation for a period of time before selling the lessee retained obligation. The buyer entity sells the lessee retained obligation to a further buyer entity before t years from the purchase have elapsed. A further buyer entity can be an insurance company. The buyer entity acquiring the lessee retained obligation at the present value P₁ sells the lessee retained obligation to a further buyer before t years from the purchase have elapsed. The present value P₂ is determined according to the value S₂. The future value S₁ can be known at the time of the determining of the present value P₁. The first net gain can be a net gain for the lessee and the second net gain is a net gain for the buyer entity. The lessee retained obligation is recorded as a long term commitment by the lessee and as a present value by the buyer entity. The buyer entity comprises an insurance company. the buyer entity comprises a consortium including an insurance company. The first net gain comprises Mₛ. The first net gain can be a value greater than Mₛ. The lessee can retain an obligation to return a property. The lessee can retain an obligation to pay an additional rent and the lessee can retain an obligation to hold the lessor harmless.

### DESCRIPTION OF THE DRAWING

FIGS. 1, 2 show alternate embodiments of the method of the present invention.

### DESCRIPTION OF THE PREFERRED EMBODIMENT OF THE INVENTION

It is well known that GAAP does not permit most business entities to take into consideration the present value of a future obligation when recording their long term debts on their balance sheets. However, in accordance with the present invention, liabilities can be derecognized by any entity that is permitted to do so. For example, a financial institution that issues a contract that performs the same operations of the risk reduction method 10 as described. Furthermore, it will understood that the obligations of a lessee to a lessor in a lease provided in accordance with the present invention can include such obligations as the duty to make a payment, including the obligation make specific periodic payments, the obligation to return property in a good condition, or in the same condition, the duty to return property in a timely manner, the duty to pay additional rent under specified circumstances, the duty to insure a property, the duty to hold the lessor harmless for injuries, and others.

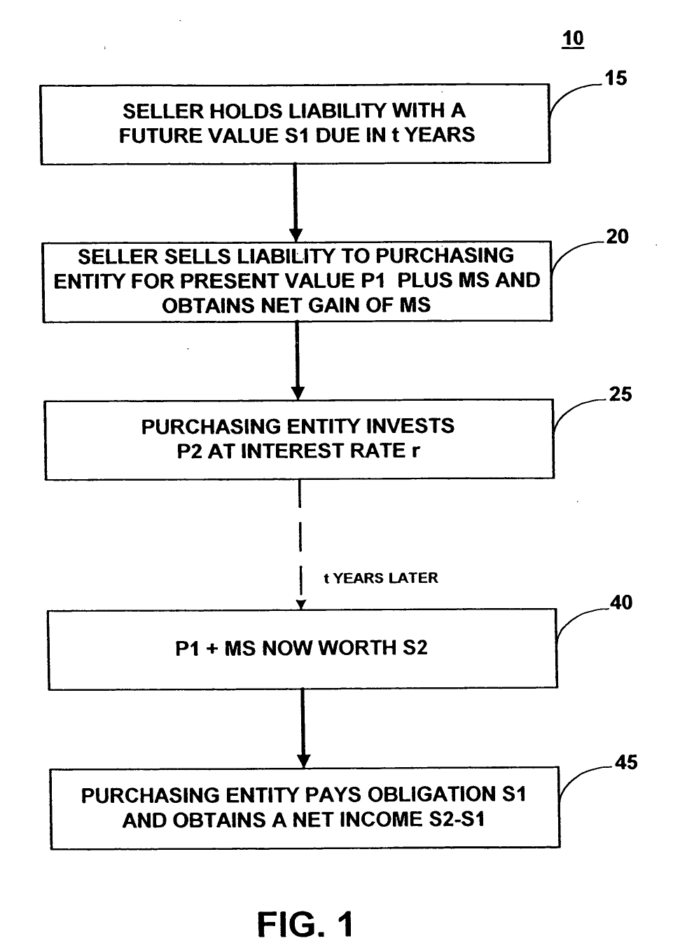

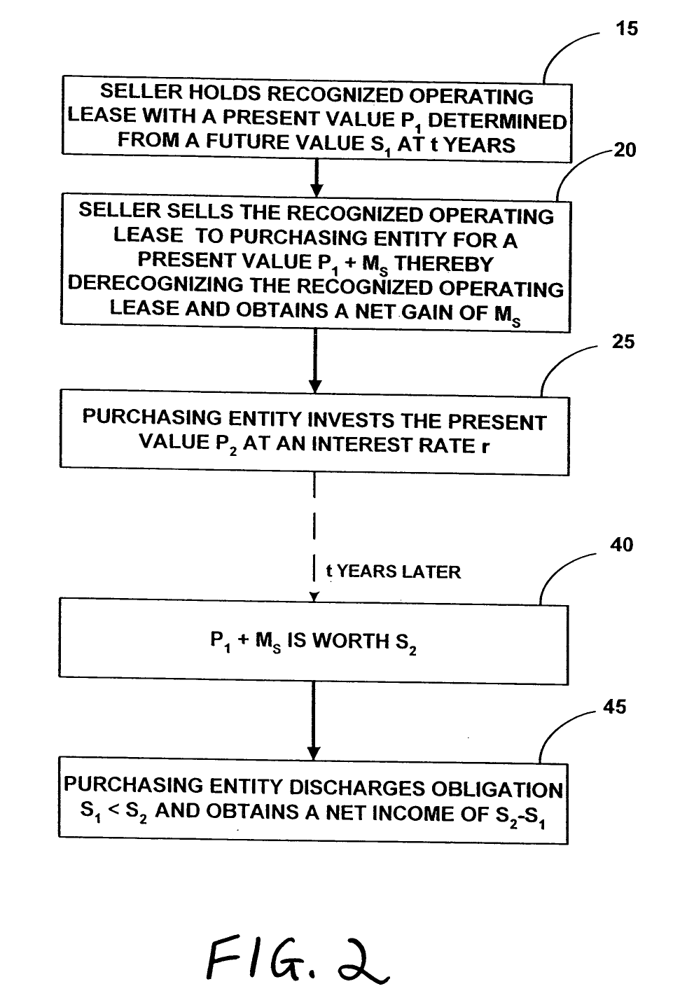

Referring now to FIG. 1, there is shown risk reduction method 10 of the present invention. In risk reduction method 10 a business entity holds a liability having a present value P₁ and a future value S₁ as shown in block 15. The liability is due in t years. The value P₁, the present value of the future value of S₁ as set forth in block 15, is the well 10 known present value P which is calculated from a known future value S in the manner set forth below, which is well understood by those skilled in the art. The equation for performing the calculation of the present value P includes the rate of interest r and the amount of time the money is invested t.

In general, the present value P of a future obligation can be calculated from the well known equation for determining a future value S when a present value P is known:

S=P(1+r).

Performing a well known algebraic reduction yields:

S/(1+r)=P(1+r)/(1+r).

S/(1+r)=P.

Transposing the result of the algebraic reduction yields the equation for the present value P:

P=S/(1+rt),

where P is thus the amount of money that must be invested at the present time in order to produce the known future value S after t years at a rate of interest r where r can be zero or any value greater than zero.

In accordance with the method of the present invention the holder of the liability sells the liability to a purchaser company that can eliminate liabilities as defined by GAAP, wherein liability is understood to mean probable future sacrifices of economic benefits arising from present obligations of a particular entity to transfer assets or provide services to other entities in the future as a result of past transactions or events. Since the seller of the liability no longer faces a future sacrifice of economic benefits due to the liability, the liability is derecognized for the seller.

The purchaser can, for example, be an insurance company or a consortium including an insurance company. Such an entity can be defined as the purchaser herein. The sale is performed for a value P₂ equal to the present value P₁ plus a profit margin Mₛ for the seller as shown in block 20 of risk reduction method 10. As shown in block 25, the purchaser invests the received value P₂ for a period of t years at a rate of interest r. After t years of investment in this manner, the value P₂=P1+Mₛ has grown to S₂ as shown in block 40. However, the purchaser only owes the face value S₁ at that time, where S₁ is less than S₂. Therefore, when the purchaser pays the obligation S₁ it receives a net income of S₂−S₁ as shown in block 45.

As an example, consider the following. Assume the net present value of $100 due in ten (10) years is $30 in present dollars. Further assume that a purchasing entity purchases this debt in exchange for a payment from the seller of $45 in cash today. The liabilities of the seller are reduced by $100, cash is reduced by $45, and the seller recognizes the difference of $55 as income.

The buyer in this example receives $45 in the present. According to the assumption used above, $30 today is worth $100 in ten (10) years, $45 today is worth $150 in ten (10) years. Thus, in this example, the purchaser will discharge the note at its face value of $100 in then (10) years and earn a profit of $50, the difference between $150 and $100. As this example shows both the buyer and seller can make a profit on the transaction. As a further consequence of the present invention profits are realized that otherwise would not and the U.S. Treasury also benefits by collecting additional taxes since each transaction is taxable.

It will be understood that the values of P₁, P₂ and S₂ depend on the interest rate r, which is unknown at the time of the sale set forth in block 20. Thus, the buyer incurs a risk in this method. However, the obligation is a known value S₁. This eliminates some of the underwriting risk.

An insurance company normally assumes two risks. One of the risks is a casualty risk similar to the risk involved in, for example, life or health insurance. This risk is eliminated in risk reduction method 10 because the amount of the liability and the date it comes due are both known. The other risk is the rate of return r. This risk continues to be borne by the insurance company.

Thus, when an insurance company performs the risk reduction method 10, the insurance company performs its essential service, it underwrites a risk. At the same time the insurance company provides the insured with an opportunity to reduce its liabilities and increase its net profit and hence its net worth. Risk reduction method 10 can permit insurance companies to assume a risk whose future value is known. Risk reduction method 10 can permit corporations to reduce debt, increase net profit, increase their net worth, increase their cash flow and improve their credit rating. Improving their credit rating can permit some companies to borrow working capital at lower rates thereby further increasing their profits, net worth and cash flow.

Financial debt holders benefit from risk reduction method 10 by improving the quality of their credit and by reducing the amount of bad debts the financial institution will incur. The purchaser benefits by increasing its total business with a known risk and a fixed dollar obligation and a known due date. Furthermore, in the case where the purchaser is an insurance company, the insurance premium is a single payment paid in advance. As previously described, the purchaser can be an insurance company, a consortium including an insurance company or any other entity permitted to perform the operations of the risk reduction method 10 as described. Liability as used herein can include, without limitation, debts, mortgages, notes, commercial paper, bonds, deferred tax liabilities, or any interest bearing obligation, a portion of which is due more than twelve months later in accordance with GAAP.

Without further elaboration, the foregoing will so fully illustrate our invention that others may, by applying current or future knowledge, readily adapt the same for use under various conditions of service.

1. A method for derecognizing the commitment of a lessee in an operating lease, comprising the steps of:
(a) holding by a lessee a recognized operating lease wherein the recognized operating lease has an obligation to a lessor, including an obligation to make a rental payment, and a fixed future value S₁;
(b) determining the present value P₁ of the recognized operating lease in accordance with the fixed future value S₁;
(c) buying the recognized operating lease from the lessee by a buyer entity for a present value P₂ greater than the present value P₁ wherein the lessee releases the obligation make the rental payment, wherein the releasing of the obligation provides a first net gain to the lessee whereby the recognized operating lease is derecognized to provide a derecognized operating lease;
(d) holding the derecognized operating lease and storing information regarding the derecognized operating lease in a computer by the buyer entity for a period of time; and
(e) discharging a liability of the derecognized operating lease at the end of the period of time by the buyer entity for the future value S₁ that is less than a future value S₂ determined in accordance with the present value P₂ thereby providing a second net gain to the buyer entity.

2. The method for derecognizing the commitment of a lessee of claim 1, wherein the lessee retains at least one obligation to provide a lessee retained obligation.

3. The method for derecognizing the commitment of a lessee of claim 2, wherein the lessee retained obligation comprises an obligation to return a property.

4. The method for derecognizing the commitment of a lessee of claim 2, wherein the lessee retained obligation comprises an obligation to make an increased rental payment under specified conditions.

5. The method for derecognizing the commitment of a lessee of claim 2, wherein the lessee retained obligation comprises an obligation to hold the lessor harmless.

6. The method for derecognizing the commitment of a lessee of claim 1, wherein the present value P₂ is determined according to the present value P₁.

7. The method for derecognizing the commitment of a lessee of claim 2, wherein the present value P₁ is determined according to a time t years prior to the time at which the value of the lessee retained obligation reaches S₁.

8. The method for derecognizing the commitment of a lessee of claim 7, wherein the buyer entity holds the lessee retained obligation for a period of time before selling the lessee retained obligation.

9. The method for derecognizing the commitment of a of claim 8, wherein the buyer entity sells the lessee retained obligation to a further buyer entity before t years from the purchase have elapsed.

10. The method for derecognizing the commitment of a lessee of claim 8, where the further buyer entity is an insurance company.

11. The method for derecognizing the commitment of a lessee of claim 8, wherein the buyer entity acquiring the lessee retained obligation at the present value P₁ sells the lessee retained obligation to a further buyer before t years from the purchase have elapsed.

12. The method for derecognizing the commitment of a lessee of claim 7, wherein the present value P₂ is determined according to the value S₂.

13. The method for derecognizing the commitment of a lessee of claim 1, wherein the future value S₁ is known at the time of the determining of the present value P₁.

14. The method for derecognizing the commitment of a lessee of claim 1, wherein the first net gain is a net gain for the lessee and the second net gain is a net gain for the buyer entity.

15. The method for derecognizing the commitment of a lessee of claim 1, wherein the lessee retained obligation is recorded as a long term commitment by the lessee and as a present value by the buyer entity.

16. The method for derecognizing the commitment of a lessee of claim 1, wherein the buyer entity comprises an insurance company.

17. The method for derecognizing the commitment of a lessee of claim 16, wherein the buyer entity comprises a consortium including an insurance company.

18. The method for derecognizing the commitment of a lessee of claim 1, wherein the first net gain comprises Mₛ.

19. The method for derecognizing the commitment of a lessee of claim 1, wherein the first net gain comprises a value greater than Mₛ.
